(19) United States
(12) Patent Application Publication
(10) Pub. No.: US 2019/0197201 A1
(43) Pub. Date: Jun. 27, 2019

(54) VEHICLE DURABILITY MODELING

(71) Applicant: Faraday&Future Inc., Gardena, CA (US)

(72) Inventor: Alexander S. Ozark, Redondo Beach, CA (US)

(21) Appl. No.: 15/721,115

(22) Filed: Sep. 29, 2017

Related U.S. Application Data
(60) Provisional application No. 62/402,134, filed on Sep. 30, 2016.

(51) Int. Cl. G06F 17/50

(52) U.S. Cl. CPC G06F 17/5009; G06F 2217/14; G06F 2217/02; G06F 17/5095

(57) ABSTRACT

Various techniques related to generating a simulated test track for a vehicle are disclosed. The techniques can include accessing information indicative of a roughness for each of a set of real-world roadways. The techniques can also include accessing information indicative of a number of vehicles that traverse at least some of the set of roadways. The techniques can further include building a model, based on the information indicative of a roughness and the information indicative of a number of vehicles, the model operable to generate a superset of simulated roadways that correspond to the roughness of the set of roadways. The techniques can include generating, via the model, the superset of simulated roadways that correspond to the roughness of the set of roadways. The techniques can additionally include determining the one or more stresses imparted to the simulated vehicle component of the vehicle.

### CROSS-REFERENCE TO RELATED APPLICATIONS

This application claims the benefit of U.S. Provisional Application No. 62/402,134, filed Sep. 30, 2016, the entirety of which is hereby incorporated by reference.

### BACKGROUND

Vehicles, such as automobiles, are becoming increasingly complex as they include increasingly large numbers of components and features. As such, production of a modern vehicle can take many iterative cycles of design, test, evaluation, and redesign for various components of the vehicle. Test of a vehicle or component can include operating a vehicle over a test track to simulate usage by a user. However, test tracks may not adequately represent real world road conditions for target users. Furthermore, use of physical real-world test tracks can constrain testing of changes to components of a vehicle. In particular, the availability of physical test tracks does not scale with the exponential increase in the complexity and testing needs of modern vehicle development. Thus, there is need for improvement in the field of vehicle testing.

### SUMMARY

The present disclosure describes various techniques that relate to generating a simulated test track for a vehicle. The techniques can include accessing information indicative of roughness for each of a set of real-world roadways. The techniques can also include accessing information indicative of a number of vehicles that traverse at least some of the set of real-world roadways, the number of vehicles representative of a usage pattern for the vehicle. The techniques can additionally include building a model, based on the information indicative of roughness and the information indicative of a number of vehicles, the model operable to generate a superset of simulated roadways that correspond to the roughness of the set of real-world roadways. The techniques can further include generating, via the model, the superset of simulated roadways that correspond to the roughness of the set of real-world roadways, the superset of simulated roadways representative of a target environment for operation of a vehicle. The techniques can also include determining one or more stresses imparted to a simulated vehicle component of the vehicle including applying at least some of the superset of simulated roadways to the simulated vehicle component of the vehicle.

The techniques can include modifying the one or more simulated vehicle components based on the determining the one or more stresses imparted to the simulated vehicle component of the vehicle. The generating the superset of simulated roadways can include generating, based on the information indicative of roughness, a frequency and an amplitude of a wave component of a wave, the frequency and amplitude corresponding to a roughness of the set of real-world roadways. The frequency and the amplitude can be generated using an ISO 8608 standard. The wave can be one of a plurality of waves and some of the plurality of waves can be varied and correspond respectively to different tracks of wheels of a vehicle. The one or more simulated vehicle components can include suspension components and two waves of the plurality of waves can be offset to induce simulated roll in the simulated suspension components.

The techniques can also include determining, based on the applying the simulated roadway to the one or more simulated vehicle components, a subset of the superset of simulated roadways. The subset can be determined by identifying a portion of the superset of simulated roadways that induce damage to the one or more simulated vehicle components substantially equivalently to damage induced by the superset of simulated roadways. The information indicative of roughness can include information accessed from the Highway Performance Monitoring System (HPMS). The model can be operable to generate a number of simulated discrete road segments each associated with a roughness value, each simulated discrete road segment corresponding to a discrete segment of the set of roadways and corresponding roughness value. The model can include a Markov Chain.

The techniques can further include accessing vehicle speed data indicative of a speed of a vehicle that traverses at least some of the set of roadways, wherein the determining the one or more stresses imparted to the simulated vehicle component of the vehicle is based on the vehicle speed data. The determining the one or more stresses imparted to the simulated vehicle component of the vehicle can be based on the vehicle speed data includes modeling the one or more simulated vehicle components as a multibodydynamic vehicle model. The applying the superset of simulated roadways to the one or more simulated vehicle components can include determining a pseudodamage for each of the one or more simulated vehicle components. The techniques can further include accessing one or more road types including at least one of a highway, arterial, collector, or residential. The building the model can be based on the one or more road types. The techniques can also include accessing one or more road geometries including at least one of a curvature, elevation, or bank angle. The building the model can be based on the one or more road geometries.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a set of roadways and corresponding roughnesses;

FIG. 2 illustrates an example model to generate simulated roadways;

FIG. 3 illustrates a simulated roadway output by the model of FIG. 2;

FIG. 4 illustrates subsets of a superset of simulated roadways;

FIG. 5 illustrates results of applying a simulated roadway to a vehicle component;

FIG. 6 is a flowchart including features of the disclosure;

FIG. 7 is a flowchart including features of the disclosure; and

FIG. 8 illustrates an example of a computing system in which one or more embodiments may be implemented, according to embodiments of the present disclosure.

Other aspects and advantages of the invention will become apparent from the following detailed description taken in conjunction with the accompanying drawings which illustrate, by way of example, the principles of the described embodiments.

### DETAILED DESCRIPTION

Design and validation of vehicles (such as automobiles) can be an expensive and time consuming process. This is true despite the existence of design aids that can expedite design and redesign of vehicle components. For example, design of suspension components of a vehicle can take into account many different competing goals including driver comfort, vehicle performance, maintainability, and longevity. Furthermore, iterative changes to components can occur as a vehicle is designed and refined to balance and improve various aspects of the vehicle. Given complexities of modern vehicles, alteration of a single component can necessitate changes to other components of the vehicle. As such, testing takes a central role in the design and development of modern vehicles to verify changes to components and their effects on the vehicle's attributes.

As various changes to components of a vehicle occur, it can be beneficial to verify that the changes are beneficial and/or achieve the desired results. A traditional test methodology involves operating the vehicle on a test track to simulate real world usage. A test track can simulate various conditions that a vehicle may be expected to encounter during its operational life (e.g., various road conditions, obstacles, bumpiness, etc.). However, because real-world test tracks are generally physical tracks, physical components may need to be manufactured and integrated into a vehicle for test. Physical production of vehicles for test presents several issues regarding verification of vehicle/component design. For example, use of the test track may need to be scheduled and may occur long after component(s) are designed. Therefore, a designer may be delayed from verifying results of their changes to components, preventing designers from being able to evaluate various options for modification of component(s) in real time. Furthermore, because of scarcities of use of a physical test track inherent to scheduling test tracks, the test vehicle may include several modified components that are tested concurrently. Thus, it may be difficult to ascertain results to the vehicle from changes to each of several individual components.

Additional difficulties pertain to the use and design of a test track itself. A physical test track may be substantially static and represent only one set of obstacles (or certain obstacles that may be selected from a set of obstacles). However, different vehicles may have different target environments for use by differing target user sets. For example, a sports car may be subjected to different driving patterns/conditions than an off road vehicle. A vehicle targeted for marketing within the United States may have a different target user base and/or driving conditions than a vehicle targeted for marketing within Europe. As such, use of physical test tracks may limit flexibility in the selection of various road conditions to which a vehicle (or vehicle components) is subjected.

Disclosed herein are techniques for generating simulated roadways for subjected component of a vehicle to in order to evaluate longevity, performance, or other aspects of the components or the vehicle to which the components pertain. The techniques can include receiving or determining information determinative of roughness of a set of real-world roadways. Roughness, as used here, refers to deviations in the direction of a normal vector of a roadway surface from its ideal form. Roughness can be a scalar value indicative of an amount of stress that a vehicle will be subjected to from the surface texture of a roadway as the vehicle traverses a roadway. Additionally, information can be received or determined indicating a number of vehicles that traverse each roadway in the set of roadways and/or an average speed of vehicles as they traverse each roadway. The set of roadways can be indicative of a target user base for a vehicle (e.g., representative of roadways that intended users of the vehicle will traverse). The information indicative of roadway roughness and the information indicative of the number of vehicles that traverse each roadway can be indicative of real world usage of the vehicle by the target user base.

Using the information indicative of roughness, the information indicative of the number of vehicles, and/or the information indicative of an average speed of vehicles that traverse the roadways, a model can be constructed to generate a simulated roadway that corresponds to the set of physical roadways. The model can be used to generate the simulated roadway in discrete sections that can each match a discrete section of the set of real-world roadways. The simulated roadway can be applied to one or more models of vehicles or components of vehicles to determine effects of the simulated roadway to the components or vehicle. Furthermore, the simulated roadway can be filtered and/or reduced to a subset of roadways that are identified to likely be damaging to vehicle component(s) as the vehicle traverses the subset. The subset can enable more expeditious modeling of a vehicle and can be useful for evaluating changes to components as components are iteratively modified, tested, and evaluated, for example.

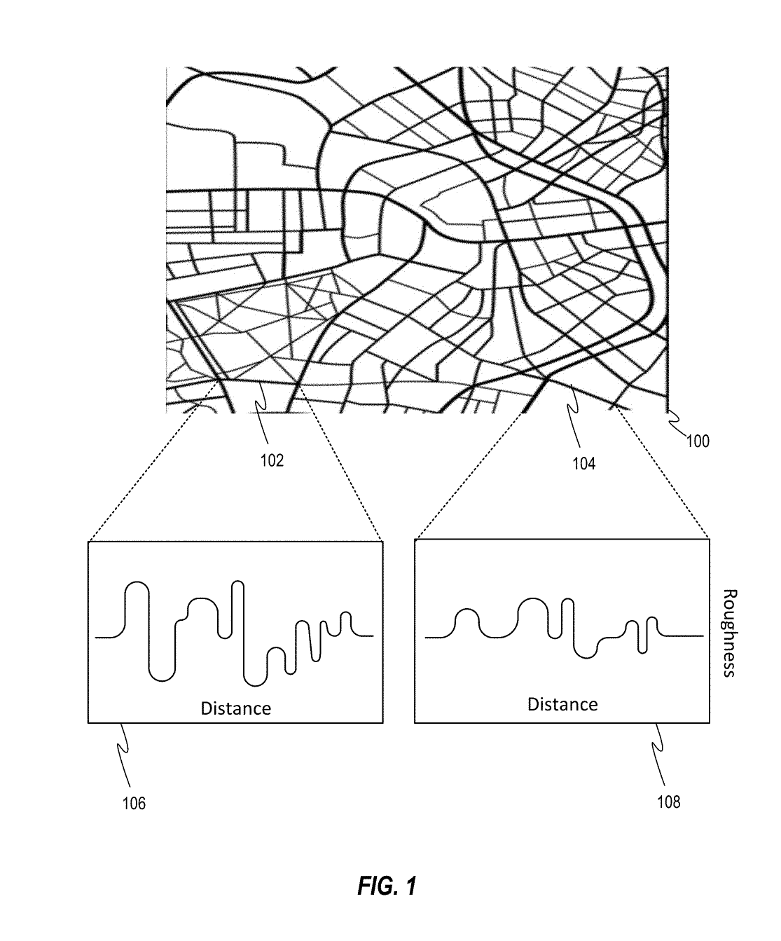

FIG. 1 illustrates a map 100 including several roadways. The map can represent a set of real-world roadways. Also illustrated are two distinct sections of roadways 102 and 104 respectively. A roughness profile 106 is illustrated as corresponding to roadway section 102. Roughness profile 106 includes several local changes in elevation of a surface of roadway section 102. Roughness profile 108 similarly corresponds to example roadway section 104. As illustrated, example roadway section 102 is relatively rougher than example roadway section 104 (as indicated by more extreme and more frequent variances in changes of roadway elevation in a direction normal to the surface of the roadway section. A higher degree of roughness can indicate, for example, that a roadway has more potholes, more frequency potholes, or other terrain features.

Roadway roughness information can be gathered through publically available or other databases or by directly sampling or sensing roughness from a set of real-world roadways. For example, International Roughness Index (IRI) information corresponding to United States roadways can be gathered from databases hosted by the Department of Transportation (such as via the Highway Performance Monitoring System (HPMS)). IRI information can be a scalar value that indicates relative roughness of a roadway section. Road roughness information can also be directly measured indicating a number of vehicles that traverse each roadway section. For example, a number of vehicles that traverse a checkpoint on a roadway section can be sampled for a certain time period (and/or be averaged over several time periods) to determine an expected/average number of vehicles that traverse a certain section of roadway. Similarly, information can be retrieved or measured indicative of average speeds of vehicles that traverse the roadways.

In certain embodiments, certain subsets of a superset of sections of roadways can be selected from databases and/or be measured. For example, a database of mapped roadway sections can be limited to certain geographic areas and/or certain types of roadways (e.g., highways, rural roads, etc.). In certain embodiments, a subset of vehicles can be used to determine a number of vehicles that traverse each roadway for a given time period. For example, vehicles may be limited to passenger cars, vans, or other vehicles corresponding to desired types of vehicles to be tested from a generated model. Roughness values of roadways can be delineated and/or binned into several categories to group the roadways. Furthermore, roadways can be separated into discrete sections of roadways of a certain length, each with corresponding roughness information and number of vehicle information. For example, roughness values can be obtained (for example, average) for 100 meter discrete sections of roadway (or any other length).

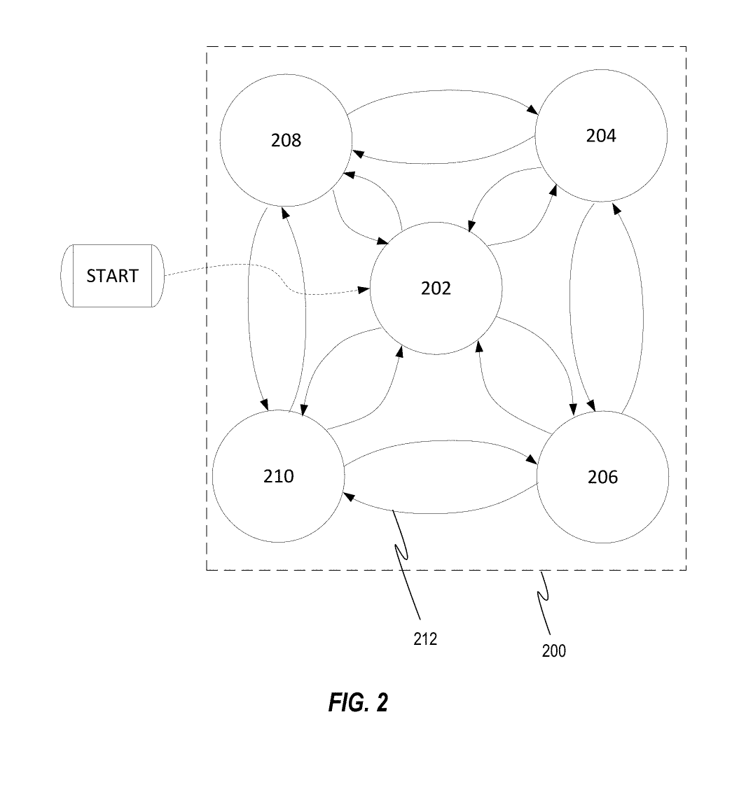

FIG. 2 illustrates an example model 200 for generation of simulated test track(s) that correspond to information gathered regarding the set of real-world roadways corresponding to a target user base. Model 200, as illustrated, can be a Markov Chain (MC) model. A MC can include various states 202-206 and corresponding probabilities for transitions 212 between the states. In certain embodiments, each state 202-206 can correspond to a different bin of roughness values of roadway sections determined from a set of roadways and can also correspond to a discrete section of roadway to which the roughness value is associated. The probabilities that correspond to each transition 212 between a state can indicate a probability that a vehicle of a target user will traverse roadways with corresponding combinations of roughness values during operation of the vehicle. The probabilities can be determined based on the information indicative of the number of vehicles that traverse the roadway section and/or the number of roadway sections in each roughness value bin, for example.

By following the MC model 200 illustrated in FIG. 2, a simulated roadway can be generated. For example, each state 202-206 of the MC model 200 can correspond to a discrete section of sampled roadway. By transitioning between the states at the probabilities indicated, a simulated roadway of varying lengths can be generated. A simulation of sufficient length will, on average, substantially match roughness and number of vehicle information gathered for a set of roadways for a target user base.

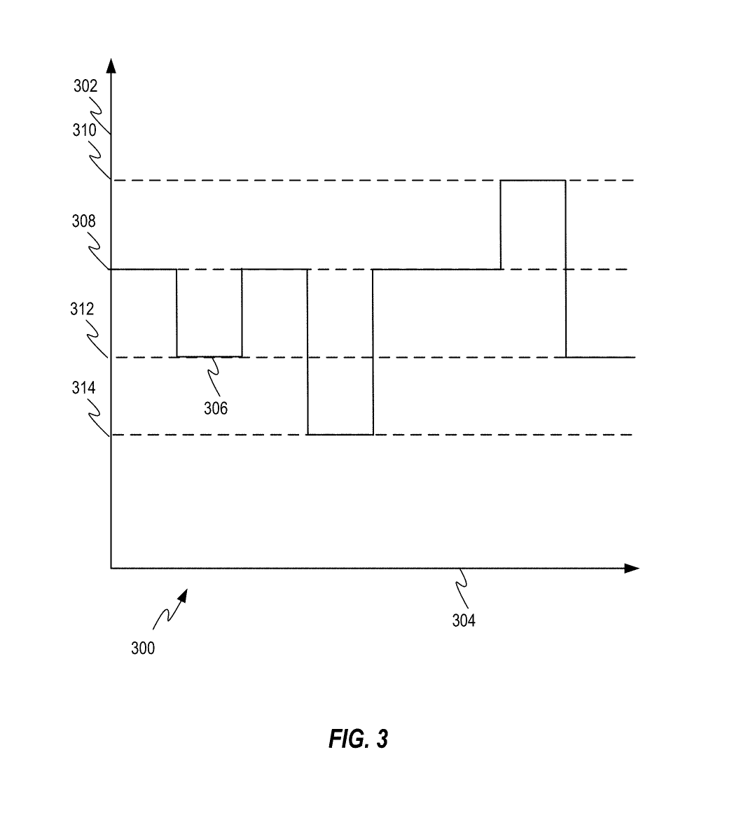

The results of using the MC model 200 can be a step function as illustrated by graph 300 of FIG. 3 wherein each step (such as step 306) corresponds to a state 202-206 of the MC model 200. Each step 306 can correspond to a discrete section of roadway. The horizontal axis of graph 300 can represent a distance whereas the vertical axis can represent a roughness value. As illustrated, a roughness value can be represented by multiple steps. For example, roughness value 308 corresponds to three separate steps. Roughness value 312 corresponds to two steps. Roughness values 310 and 314 each correspond to one roughness value in graph 300. Note that the distance corresponding to each set can be adjusted to match data sampled from a set of real-world roadways. By adjusting the length of each step, the granularity of the simulated roadway can be adjusted. In certain embodiments, a non-step (e.g., continuous graph) can be generated having a very fine granularity of samples roadways.

Depending on the length of each generated and/or sampled roadway section, the generated model may or may not have sufficient granularity to simulate roadway conditions with a vehicle component. In certain embodiments, frequency information and/or more granular information may be supplemented into the generated model to more realistically simulate roadway conditions. For example, each generated roadway section may be 100 meters long (or any other distance) and may correspond to a particular roughness value (or range of roughness values). However, frequency and/or amplitude information may be added to the segment to simulate individual bumps and/or divets in a roadway surface. In certain embodiments, Fourier series and/or Weierstrass functions can be used to model a roadway and/or add frequency components to the model. For example, frequency components with randomized amplitudes and/or other frequencies/amplitudes can be added to model(s). In certain embodiments, International Standards Organization (ISO) 8608 can be used to define amplitude versus frequency requirements for generating a Fourier series, a Weirstrass function, and/or for supplementing either.

In certain embodiments, the generated model can be separated into two separate tracks or two separate tracks can be individually generated using disclosed techniques. The two separate tracks can correspond to paths traversed respectively by left and right wheels of a vehicle. In certain embodiments, components (e.g., waveform components of Fourier series) of two generated tracks can be offset or randomized to better simulate road conditions that may cause, for example, vehicle suspension components to roll between left and right sides of a vehicle. For example, a generated model can be cloned to obtain two models corresponding to tracks. Components of the models having greater than a threshold frequency can be offset and/or randomized to simulate induced roll conditions to a vehicle. Components of the model having less than the threshold may not be offset to simulate a gentle roll between the front and back of a vehicle. In certain embodiments, frequencies corresponding to a wavelength of 30 meters can be varied between left and right tracks whereas longer wavelengths can be substantially identical between left and right tracks.

Various other alterations can be utilized to modify the generated model for differing conditions. For example, amplitude and/or frequency information can be increased in magnitude to simulate degradation of certain roads. In certain embodiments, planned new or refurbished roadways can be included in the model as having relatively lower roughness information. The models can be altered to simulate various weather patterns. For example, roadways known to be subjected to ice may have increased amplitude and/or frequency components (in certain embodiments, depending on vehicle type, for example, e.g., a sports car may not be expected to be driven during wintertime).

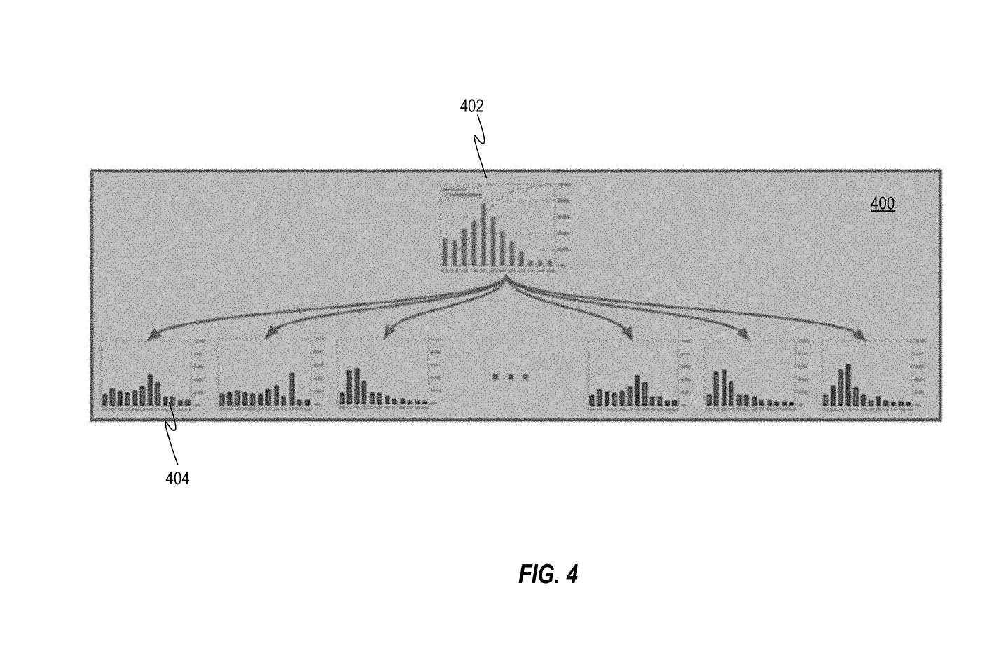

FIG. 4 illustrates a histogram 402 that correspond to a set of generated roughness values that can match a set of real-world roadways. As disclosed, MC model 200 can be used to generate simulated discrete roadway sections. The generated roadway sections can be binned and/or counted, as discussed regarding FIG. 3 into a plurality of discrete roughness values. The discrete roughness values can be counted to obtain a primary histogram (such as histogram 402). A plurality of secondary histograms (such as histograms 404) can be generated from primary histogram 402 to, for example, to correspond to different tracks, geographic areas, road types, vehicle types, or other attributes. In certain embodiments, roughness values for each of the secondary histograms (such as histograms 404) can, in summation, equal roughness values of histogram 402. In certain embodiments, secondary histograms (such as histograms 404) can each be used to generate a discrete section of simulated roadway. Each of the histograms can represent a discrete section with randomized (or pseudo-randomized) roughness value(s) that, when collated into a primary histogram (such as histogram 402) can match roughness values of a real-world set of roadways. Each of the secondary histograms can be adjusted based upon, for example, road types, information indicative of vehicle speed(s), information indicative of a volume of vehicles, or other. Example road types include a highway, arterial, collector, or residential roadway.

In certain embodiments, a vehicle speed can be gathered or estimated for existing databases and/or derived by associating a speed with a gathered roughness, road type, and/or other information. In certain embodiments, vehicle speed information can be gathered directly from vehicles that traverse roadways. Vehicle speed information can be used to determine stresses to vehicle components that travel at the speeds across roadways having various corresponding roughness values. The disclosed simulated roadway segments can be used to model effects to vehicle components with the vehicle speed information.

As a model of a vehicle is simulated to traverse a simulated roadway sections of varying roughness levels, stresses applied to components of the vehicle can be modeled (for various lengths of simulated roadway). The stresses can aid in determining if a particular vehicle component may be damaged when a vehicle traverses the corresponding real-world roadways. For example, a simulated roadway (or sets of simulated roadways corresponding to different tracks) can be 250,000 kilometers long if each segment is 100 meters and 2.5 million segments are used.

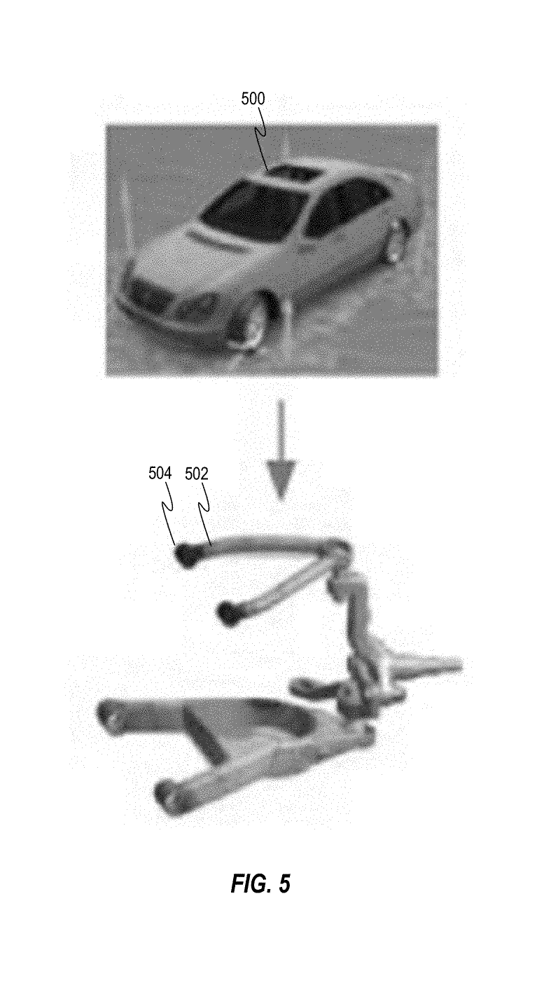

A multibodydamic (BMD) vehicle model is an example model that can be used to model stresses. A Finite Elements Analysis (FEA) can be performed to determined stresses applied to individual components. Using these techniques, a psuedodamage (PD) model can be generated for various components of a simulated vehicle. The PD can simulate a typical stresslife curve for a component. FIG. 5 illustrates a simulated vehicle 500 that can be stressed using the disclosed techniques. A component 502 of the suspension of simulated vehicle 500 is illustrated. The component 502 is illustrated as being shaded according to various PD values associated with various area of component 502. Component 502 can be color coded, shaded, or otherwise illustrated to represented PD values of various areas of the component. For example, area 504 of component is illustrated as being relatively darkly shaded. Area 504 can represent a relatively stressed (e.g., high PD value) area of component 502. This may indicate that area 504 may be destructively deformed after traversing the simulated roadway or may otherwise by subjected to high stress. Using these techniques, component 502 can be redesigned to avoid unacceptable levels of psuedodamage, optimize component design to balance cost/weight/performance, and/or perform other alterations to component 502.

In certain embodiments, generated simulated roadways can be filtered and/or down selected to generate a more compact subset of roadways. For example, a simulated set of roadways of 1,000 miles (that can be generated through use of model 200 and/or histogram(s) as disclosed herein) can be down selected to 100 miles of roadway. A down selected subset of roadways can be elected by determining that the subset of roadways contribute a relatively large amount of psuedodamage to component(s) of a vehicle. The subset of simulated roadway segments can aid in expediting simulated testing of vehicle components. For example, a smaller subset may require less time and/or processing power than a larger set. A subset can enable a designer to test components in near real time to determine if changes to the components result in a reliable component when tested. In certain embodiments, psuedodamage from a superset of simulated roadways can be used to down select to a subset of simulated roadways. For example, a determination can be made that a certain subset of roadways induces the majority of damage to certain components. The subset can then be down-selected.

Certain subsets of down selected roadway sections can be associated with certain vehicle types (e.g., sedan, coupe, sports utility vehicle, truck, etc.), certain types of components (e.g., suspension, drivetrain, interior, etc.) or other. In certain embodiments, various groups of subsets can be down selected for different purposes. For example, a certain subset may be used to perform a relatively quick test on component(s) to quickly ascertain a level of confidence pertaining to the components' reliability. A certain subset may be used to perform a more thorough evaluation of the components and/or to target the components. Certain subsets may include adding or repeating simulated sections of roadways that were not in the superset used to generate the subset. For example, two subsets from two different supersets can be combined to, for example, ascertain effects from two different modeled geographic areas. Some subsets can be appended with additional roadway segments to, for example, perform a more stringent test on a component.

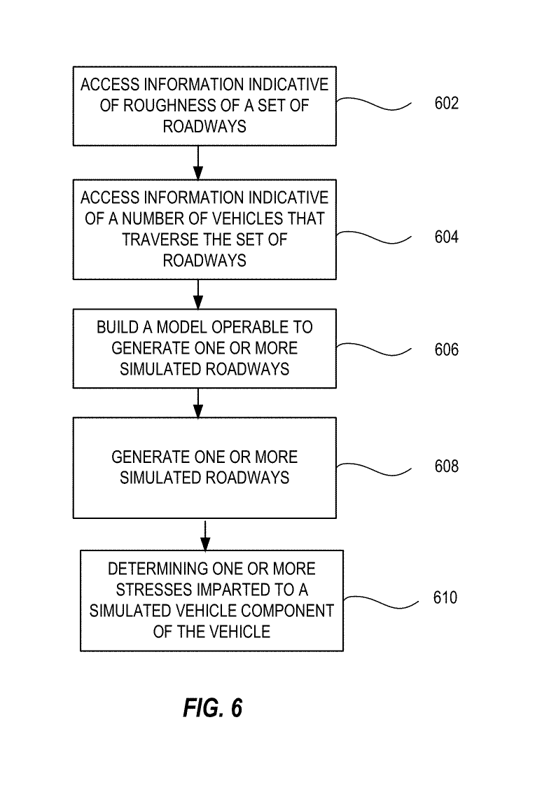

FIG. 6 illustrates a flowchart 600 illustrating techniques of the disclosure. At 602, information can be accessed indicative of one or more roughness values for a set of real-world roadways. As disclosed, the roughness values can be IRI values. The set of real-world roadways can be divided into discrete sections, each corresponding to a roughness value. At 604, information can be accessed indicative of a number of vehicles that traverse the set of real-world roadways. For example, an average annual daily traffic value can be accessed from a database, traffic information can be mined from peer to peer traffic applications, or other databases having information indicative of a number of vehicles that traverse a roadway for a given time period.

At 606, a model can be built to generate one or more simulated roadways (e.g., a superset of simulated roadways). The one or more simulated roadways can correspond, in roughness, to the set of roadways for 602 and 604. The model can be a MC model that uses probabilities to change states corresponding to roughness values. The probabilities can be used to generate simulated roadways having distribution of roughness values substantially equal to the set of real-world roadways. At 608, the model can be used to generate a one or more simulated roadway sections. At 610, one or more stresses imparted to a simulated vehicle component of the vehicle can be determined. Roadway sections can be applied to one or more simulated vehicle components to determine, for example, a reliability or longevity for each of the components for the simulated roadway (and thus corresponding to the set of real-world roadways).

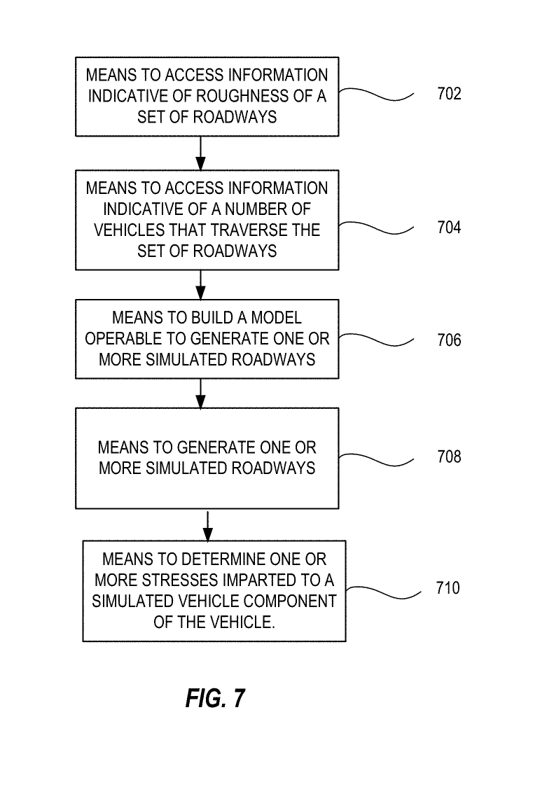

FIG. 7 illustrates a flowchart 700 illustrating a device that can be used to implement techniques of the disclosure. At 702 is a means to access information indicative of one or more roughness values for a set of real-world roadways. The means can be a processor. As disclosed, the roughness values can be IRI values. The set of real-world roadways can be divided into discrete sections, each corresponding to a roughness value. At 704 is a means to access information indicative of a number of vehicles that traverse the set of roadways. The means can be a processor. For example, an average annual daily traffic value can be accessed from a database, traffic information can be mined from peer to peer traffic applications, or other databases having information indicative of a number of vehicles that traverse a roadway for a given time period.

At 706 is a means to build a model operable of generating one or more simulated roadways. The means can be a processor. The one or more simulated roadways can correspond, in roughness, to the set of real-world roadways of 702 and 704. The model can be a MC model that uses probabilities to change states corresponding to roughness values. The probabilities can be used to generate simulated roadway(s) having distribution(s) of roughness values substantially equal to the set of real-world roadways. At 708 is a means to generate the one or more simulated roadway sections. The means can be a processor that can use the model generated at 706. At 710 is a means to determine one or more stresses imparted to a simulated vehicle component of the vehicle. The means can include applying roadway sections to one or more simulated vehicle components to determine, for example, a reliability or longevity for each of the components for the simulated roadway (and thus corresponding to the set of real-world roadways). The means can be a processor.

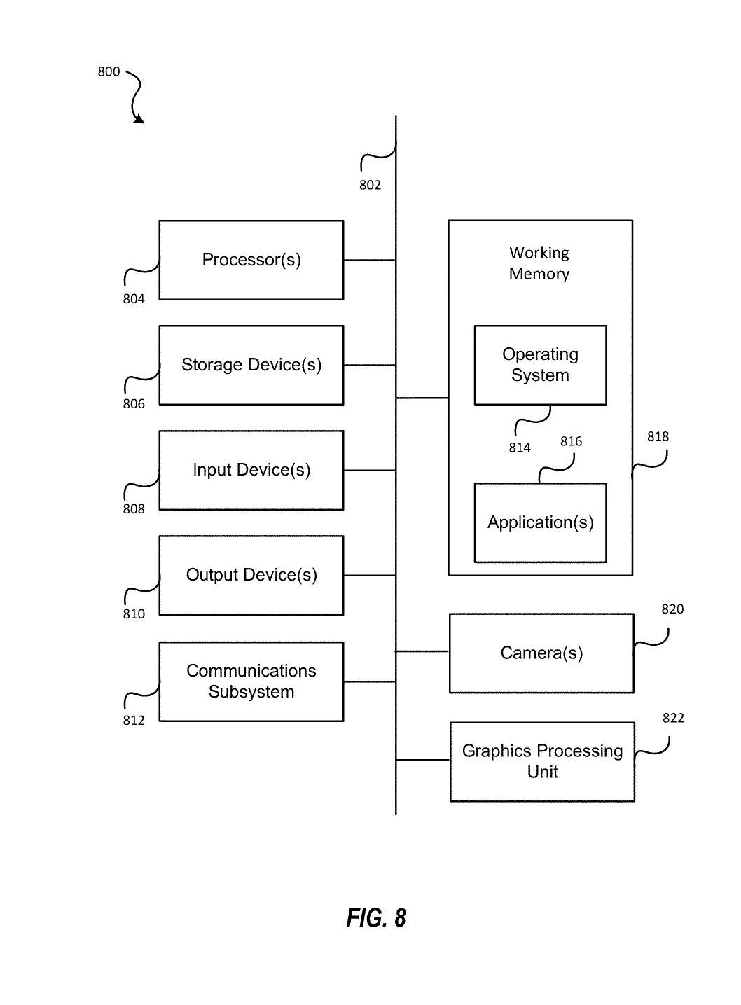

FIG. 8 illustrates an example of a computer system 800 in which one or more implementations may be implemented. Server 118 can be an example of computer system 800. Computer system 800 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 8 provides a schematic illustration of one implementation of a computer system 800 that can perform the methods provided by various other implementations, as described herein, and/or can function as the host computer system, a remote kiosk/terminal, a telephonic or navigation or multimedia interface in an automobile, a computing device, a table computer and/or a computer system. FIG. 8 is meant only to provide a generalized illustration of various components, any or all of which may be utilized as appropriate.

The computer system 800 is shown as comprising hardware elements that can be electrically coupled via a bus 802 (or may otherwise be in communication, as appropriate). The hardware elements may include one or more processors 804, including without limitation one or more general-purpose processors and/or one or more special-purpose processors (such as digital signal processing chips, graphics processing units 822, and/or the like); one or more input devices 808, which can include without limitation one or more cameras, sensors, a mouse, a keyboard, a microphone configured to detect ultrasound or other sounds, and/or the like; and one or more output devices 810, which can include without limitation a display unit such as the device used in implementations of the invention, a printer and/or the like.

In some implementations of the implementations of the invention, various input devices 808 and output devices 810 may be embedded into interfaces such as display devices, tables, floors, walls, and window screens. Furthermore, input devices 808 and output devices 810 coupled to the processors may form multi-dimensional tracking systems.

The computer system 800 may further include (and/or be in communication with) one or more non-transitory storage devices 806, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 800 might also include a communications subsystem 812, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 812 may permit data to be exchanged with a network, other computer systems, and/or any other devices described herein. In many implementations, the computer system 800 will further comprise a non-transitory working memory 818, which can include a RAM or ROM device, as described above.

The computer system 800 also can comprise software elements, shown as being currently located within the working memory 818, including an operating system 814, device drivers, executable libraries, and/or other code, such as one or more application programs 816, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 806 described above. In some cases, the storage medium might be incorporated within a computer system, such as computer system 800. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 800 may be omitted or may be implemented separate from the illustrated system. For example, the processor 804 and/or other elements may be implemented separate from the input device 808. In one implementation, the processor may be configured to receive images from one or more cameras that are separately implemented. In some implementations, elements in addition to those illustrated in FIG. 8 may be included in the computer system 800.

Some implementations may employ a computer system (such as the computer system 800) to perform methods in accordance with the disclosure. For example, some or all of the procedures of the described methods may be performed by the computer system 800 in response to processor 804 executing one or more sequences of one or more instructions (which might be incorporated into the operating system 814 and/or other code, such as an application program 816) contained in the working memory 818. Such instructions may be read into the working memory 818 from another computer-readable medium, such as one or more of the storage device(s) 806. Merely by way of example, execution of the sequences of instructions contained in the working memory 818 might cause the processor(s) 804 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 800, various computer-readable media might be involved in providing instructions/code to processor(s) 804 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 806. Volatile media include, without limitation, dynamic memory, such as the working memory 818. Transmission media include, without limitation, coaxial cables, copper wire and fiber optics, including the wires that comprise the bus 802, as well as the various components of the communications subsystem 812 (and/or the media by which the communications subsystem 812 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, any other physical medium, a RAM, a PROM, EPROM, a FLASH-EPROM, any other memory device, a carrier wave as described hereinafter, or any other medium from which a computer can read instructions and/or code.

Various forms of computer-readable media may be involved in carrying one or more sequences of one or more instructions to the processor(s) 804 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various implementations of the invention.

The communications subsystem 812 (and/or components thereof) generally will receive the signals, and the bus 802 then might carry the signals (and/or the data, instructions, etc. carried by the signals) to the working memory 818, from which the processor(s) 804 retrieves and executes the instructions. The instructions received by the working memory 818 may optionally be stored on a non-transitory storage device 806 either before or after execution by the processor(s) 804.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Although the disclosure has been described with respect to specific embodiments, it will be appreciated that the disclosure is intended to cover all modifications and equivalents within the scope of the following claims.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for generating a simulated test track for a vehicle, comprising:
accessing information indicative of roughness for each of a set of real-world roadways;
accessing information indicative of a number of vehicles that traverse at least some of the set of real-world roadways, the number of vehicles representative of a usage pattern for the vehicle;
building a model, based on the information indicative of roughness and the information indicative of a number of vehicles, the model operable to generate a superset of simulated roadways that correspond to the roughness of the set of real-world roadways;
generating, via the model, the superset of simulated roadways that correspond to the roughness of the set of real-world roadways, the superset of simulated roadways representative of a target environment for operation of a vehicle; and
determining one or more stresses imparted to a simulated vehicle component of the vehicle including applying at least some of the superset of simulated roadways to the simulated vehicle component of the vehicle.

2. The method of claim 1, further comprising modifying the one or more simulated vehicle components based on the determining the one or more stresses imparted to the simulated vehicle component of the vehicle.

3. The method of claim 1, wherein the generating the superset of simulated roadways includes generating, based on the information indicative of roughness, a frequency and an amplitude of a wave component of a wave, the frequency and amplitude corresponding to a roughness of the set of real-world roadways.

4. The method of claim 3, wherein the frequency and the amplitude are generated using an ISO 8608 standard.

5. The method of claim 3, wherein the wave is one of a plurality of waves and some of the plurality of waves are varied and correspond respectively to different tracks of wheels of a vehicle.

6. The method of claim 5, wherein the one or more simulated vehicle components include suspension components and two waves of the plurality of waves are offset to induce simulated roll in the simulated suspension components.

7. The method of claim 1, further comprising determining, based on the applying the simulated roadway to the one or more simulated vehicle components, a subset of the superset of simulated roadways.

8. The method of claim 7, wherein the subset is determined by identifying a portion of the superset of simulated roadways that induce damage to the one or more simulated vehicle components substantially equivalently to damage induced by the superset of simulated roadways.

9. The method of claim 1, wherein the information indicative of roughness includes information accessed from the Highway Performance Monitoring System (HPMS).

10. The method of claim 1, wherein the model is operable to generate a number of simulated discrete road segments each associated with a roughness value, each simulated discrete road segment corresponding to a discrete segment of the set of real-world roadways and corresponding roughness value.

11. The method of claim 1, wherein the model includes a Markov Chain.

12. The method of claim 1, further comprising accessing vehicle speed data indicative of a speed of a vehicle that traverses at least some of the set of roadways, wherein the determining the one or more stresses imparted to the simulated vehicle component of the vehicle is based on the vehicle speed data.

13. The method of claim 1, wherein the determining the one or more stresses imparted to the simulated vehicle component of the vehicle based on the vehicle speed data includes modeling the one or more simulated vehicle components as a multibodydynamic vehicle model.

14. The method of claim 1, wherein the applying the superset of simulated roadways to the one or more simulated vehicle components includes determining a pseudodamage for each of the one or more simulated vehicle components.

15. The method of claim 1, further comprising accessing one or more road types including at least one of a highway, arterial, collector, or residential;
and wherein the building the model is based on the one or more road types.

16. The method of claim 1, further comprising accessing one or more road geometries including at least one of a curvature, elevation, or bank angle;
and wherein the building the model is based on the one or more road geometries.

17. A non-transitory computer readable medium comprising instructions that, when executed by one or more processors, cause the one or more processors to:
access information indicative of roughness for each of a set of real-world roadways representative of a target environment for operation of a vehicle;
access information indicative of a number of vehicles that traverse at least some of the set of roadways, the number of vehicles representative of a usage pattern for the vehicle;
build a model, based on the information indicative of roughness and the information indicative of a number of vehicles, the model operable to generate a superset of simulated roadways that correspond to the roughness of the set of roadways;
generate, via the model, the superset of simulated roadways that correspond to the roughness of the set of real-world roadways; and
determine one or more stresses imparted to a simulated vehicle component of the vehicle including applying at least some of the superset of simulated roadways to the simulated vehicle component of the vehicle.

18. The non-transitory computer readable medium of claim 17, wherein the determining the one or more stresses imparted to the simulated vehicle component of the vehicle includes determining a pseudodamage for each of the one or more simulated vehicle components.

19. A device for generating a simulated test track for a vehicle, comprising:
a processor configured to:
access information indicative of a roughness for each of a set of real-world roadways representative of a target environment for operation of a vehicle;
access information indicative of a number of vehicles that traverse at least some of the set of roadways, the number of vehicles representative of a usage pattern for the vehicle;
build a model, based on the information indicative of roughness and the information indicative of a number of vehicles, the model operable to generate a superset of simulated roadways that correspond to the roughness of the set of roadways;
generate, via the model, the superset of simulated roadways that correspond to the roughness of the set of real-world roadways; and
determine one or more stresses imparted to a simulated vehicle component of the vehicle including applying at least some of the superset of simulated roadways to the simulated vehicle component of the vehicle.

20. The device of claim 19, wherein determining the one or more stresses imparted to the simulated vehicle component of the vehicle includes determining a pseudodamage for each of the one or more simulated vehicle components.
